(19) United States
(12) Patent Application Publication
(10) Pub. No.: US 2022/0324181 A1
(43) Pub. Date: Oct. 13, 2022

(54) SYSTEM FOR JOINING THERMOPLASTIC WORKPIECES BY LASER TRANSMISSION WELDING

(71) Applicant: Leister Technologies AG, Kägiswil (CH)

(72) Inventors: Alexander FRANKE, Kerns (CH); Daniel CSATI, Kägiswil (CH)

(21) Appl. No.: 17/712,237

(22) Filed: Apr. 4, 2022

(30) Foreign Application Priority Data
Apr. 13, 2021 (EP) 21 168 160.6

(51) Int. Cl. B29C 65/16; B29C 65/82

(52) U.S. Cl. CPC B29C 65/1638; B29C 65/1616; B29C 65/1696; B29C 65/8253; B29K 2101/12

(57) ABSTRACT

A system for joining at least two workpieces of thermoplastic material by laser transmission welding, the system comprising at least one device for generating laser radiation and an imaging optics having a first optical axis, wherein laser radiation emitted by the device for generating laser radiation is guided into a joining zone and wherein the imaging optics is configured for optical imaging from a joining plane in the joining zone to a detection plane of a radiation detecting device. According to an aspect, a deflection mirror is arranged at a coupling point on a second optical axis running parallel to the first optical axis for deflecting the laser radiation from an entrance axis enclosing a non-zero angle, preferably a right angle, with the second optical axis into a direction along the second optical axis.

### CROSS-REFERENCE TO RELATED APPLICATIONS

This application claims the priority of the European patent application No. 21 168 160.6 filed on Apr. 13, 2021 in German which is incorporated herein by reference in its entirety.

### BACKGROUND OF THE INVENTION

The invention relates to a system for joining at least two workpieces made of thermoplastic material by means of laser transmission welding, the system comprising at least one device for generating laser radiation and imaging optics having a first optical axis, wherein laser radiation emitted by the device for generating laser radiation is guided into a joining zone and wherein the imaging optics is configured for optical imaging from a joining plane in the joining zone to a detection plane of a radiation detecting device.

Apparatuses, systems, and devices or methods for joining at least two workpieces made of thermoplastic material are generally known from the prior art in various forms.

DE 10 2009 049 064 A1 discloses a device for detecting the joining temperature during laser welding of thermoplastics. The device comprises a laser processing head, a pyrometer, and imaging optics that image a region occupied by the laser spot in the joining plane to the detection plane of the pyrometer. The imaging optics is chosen such that the image of the area occupied by the laser spot in the joining plane in the detection plane is larger than the detection area of the pyrometer. The device can be used to reliably detect the temperature during the joining process, so that this measurement can be used for process control.

DE 10 2005 000 002 A1 describes a method for detecting the possible formation of burns on the beam entry side of one of the joining partners during the process of laser transmission welding of plastics. For this purpose, it is proposed to detect the radiation emanating from the burn by a respective element and thus to enable a damaged component to be ejected.

JP 2016-155319 A discloses a system for non-contact continuous monitoring of a material condition and seam quality during a joining process of thermoplastic materials by laser transmission welding. The system comprises a laser radiation source emitting laser radiation having a wavelength between 0.4 μm and 1.1 μm; an optical system for redirecting and focusing laser radiation emitted by the laser radiation source into a joining zone at a boundary between two workpieces to be joined, which are mounted on a processing table; means for controlling the respective elements of the system such as the laser radiation source and a monitoring element for monitoring material condition and/or seam quality in a non-contact and non-destructive manner. A radiation thermometer of the monitoring element is provided for detecting electromagnetic radiation in the near infrared (NIR) range with a wavelength between 1.8 μm and 2.5 μm, which reaches the radiation thermometer via imaging optics from the joining zone when the joining process is performed. The temperature in the joining zone is determined from the intensity of the infrared electromagnetic radiation detected by the radiation thermometer.

WO 2018/019809 A1 relates to a joining method for joining two parts to be joined, in particular a laser welding process, wherein at least one working beam generated by a beam generation unit controlled in an open-loop or closed-loop manner by a control unit acts in a material-softening or material-melting manner on an irradiation spot on a surface of at least one part to be joined, wherein a shielding means which is impermeable to the radiation of the working beam is arranged between the beam generation unit and the parts to be joined. In order to permit a joining quality check to be carried out during the joining process, it is proposed that the temperature of the irradiation spot is measured by means of a thermal radiation measuring unit arranged on a side of the shielding means facing away from the two joining parts, and the shielding means substantially absorbs radiation in the wavelength range of the working beam and of the measuring range of the thermal radiation measuring unit. Furthermore, the disclosure relates to a joining device for carrying out the joining method according to the disclosure.

In laser transmission welding, two workpieces made of thermoplastic material are joined together by means of irradiation by laser radiation and the application of mechanical pressure. The mechanical pressure results, for example, from a clamping device in which the workpieces to be joined are clamped together or from a press fit of the workpieces to be joined. In laser transmission welding, one of the two workpieces is usually almost completely transparent to the laser radiation used and the laser radiation is transmitted through this component (almost) unhindered, whereas the other, second workpiece is highly absorbent to the laser radiation used. The transparent workpiece is typically not only largely transparent for the laser radiation used, but in principle for electromagnetic radiation at least from the visible part of the electromagnetic spectrum, hereinafter referred to as optically transparent. Optionally, optical transparency may also comprise transparency with respect to the part of the electromagnetic spectrum referred to as near infrared, which is adjacent to the long-wavelength end of the visible part of the electromagnetic spectrum, and/or for parts of the UV spectrum, which is adjacent to the short-wavelength end of the visible part of the electromagnetic spectrum. The workpiece, which absorbs the laser radiation used and is therefore intransparent, is also optically intransparent.

Due to the absorption of the laser radiation in the second workpiece, the second workpiece heats up and the thermoplastic material of the second workpiece is melted in a certain vicinity of the areas irradiated by laser radiation in the second workpiece. Due to heat conduction and/or heat transport in the workpiece, plastic material also melts in areas adjacent to the areas directly irradiated by laser radiation in the second workpiece. Likewise, due to heat conduction and/or heat transport, plastic material is melted in areas of the first, transparent workpiece through which the laser radiation passes, which are located in a certain vicinity of the areas of the second, absorbing workpiece irradiated by the laser radiation. The entirety of all areas in which the respective plastic material is melted as a result of the irradiation by laser radiation in a vicinity of the area directly irradiated by the laser radiation of the second workpiece and of the adjacent first workpiece defines a respective joining zone. Within such a joining zone, plastic material of both workpieces mixes so that the workpieces are coupled together (“joined”) after cooling of the melted plastic material under application of mechanical pressure. After cooling and (re)solidification, the entirety of all joining zones on a composite workpiece resulting from the joining of two workpieces in the laser transmission welding process produces the weld seam or, if the joining zones are not all connected, the weld seams on the composite workpiece.

It is also possible to join two workpieces by laser transmission welding, with the second workpiece also being at least largely optically transparent. When welding two workpieces formed from optically (largely) transparent plastics, laser radiation with wavelengths in the range of 1 μm can be used as an aid in combination with chemical absorbers, the chemical absorbers essentially absorbing the laser radiation and through heat generation as a result of the absorption melting the plastic material of the workpieces to be joined in the joining zone. The chemical absorbers fade in the process, so that the composite workpiece formed by joining two optically (largely) transparent workpieces by laser transmission welding is also optically (largely) transparent. Alternatively, laser radiation in the range of 2 μm wavelength can be used for joining two optically (largely) transparent workpieces by laser transmission welding, and the volume absorption in the plastic material of the workpieces to be joined can be utilized. The aim here is to weld without chemical additives such as the aforementioned chemical absorbers, for example to produce cartridges for medical technology analyses which can be evaluated using optical methods (e.g. color change of a reagent).

The joining of optically (largely) transparent workpieces using the laser transmission welding process is technically demanding. Due to the low absorption of laser radiation in the plastic material of such workpieces, the output power of the device for generating laser radiation must be correspondingly high in order to be able to melt the workpieces to be joined in a joining zone at all. Even slight impurities in the plastic material or on the interfaces of the plastic material at least in a joining zone, such as small dust particles, can heat up strongly or even ignite as a result of irradiation with the laser and thus lead to damage to the workpieces to be joined in the joining process or to massive quality defects (rejects or faulty production) of the composite workpiece formed in the joining process. Furthermore, different material thicknesses at different points where two workpieces are to be joined or welding in the region of curvatures as well as edges or corners, or more generally formulated, complicated geometries of the optically (largely) transparent workpieces to be joined, are problematic. In this case, the irradiation characteristics of laser radiation can change during the laser transmission welding process.

During absorption of laser radiation for example by plastic material of the workpieces to be joined in a laser transmission welding process, plastic material heats up in a joining zone. As a result of the heating, electromagnetic radiation, thermal radiation, is emitted at least from the joining zone. The thermal radiation can be detected by suitable radiation detecting devices configured to detect respective electromagnetic radiation. Such radiation detecting devices include, for example, pyrometers. The detection of thermal radiation emitted from a joining zone during the performance of a laser transmission welding process enables the process to be controlled, in particular by adjusting the output power of the device for generating laser radiation as a function of the measurement signals of a suitable and appropriately configured radiation detecting device.

### BRIEF SUMMARY OF THE INVENTION

On this basis, according to an aspect of the present invention it would be desirable to provide an arrangement for joining at least two workpieces made of thermoplastic material by laser transmission welding, which enables simultaneous control of the laser intensity depending on the heat development in a joining zone in a simple manner during laser transmission welding.

According to an aspect of the present invention, a system for joining at least two workpieces of thermoplastic material by laser transmission welding according to claim 1. Further advantageous embodiments of the invention are described in the respective dependent claims.

Accordingly, in a system according to an aspect of the present disclosure for joining at least two workpieces of thermoplastic material by means of laser transmission welding, it is suggested that a deflection mirror is arranged at a coupling point on a second optical axis running parallel to the first optical axis for deflecting the laser radiation from an entrance axis enclosing a non-zero angle, preferably a right angle, with the second optical axis into a direction along the second optical axis, wherein the distance between the coupling point and the joining plane along the second optical axis is smaller than the distance from the detection plane to the joining plane along the first optical axis, wherein the diameter of the deflection mirror is adapted to a cross-sectional shape and cross-sectional size of the laser radiation and, when the deflection mirror is projected onto a projection plane perpendicular to the first optical axis, the projection surface of the mirror in the projection plane is arranged completely within a minimum aperture in the beam path of the imaging optics and only partially covers the minimum aperture.

The second optical axis is the axis along which laser beam radiation propagates from the coupling point. If in the beam path provided for laser radiation at least one further optical element follows the deflection mirror, which causes a change in the propagation direction of laser radiation, then the propagation direction of laser radiation after passing this further optical element generally no longer coincides with the propagation direction specified by the second optical axis. Such a further optical element can be, for example, a focusing optic (e.g., a lens) that focuses laser radiation into a focal plane within a joining zone in order to concentrate the power density or irradiance of the laser radiation to a specific area. The joining zone is accordingly formed around this concentration area of the irradiance of the laser radiation.

Such a focusing optics can be at the same time at least a part of the imaging optics for imaging from a joining zone to the detection plane of a radiation detecting device. Generally, the first optical axis and the second optical axis do not coincide.

A minimum aperture in the optical path of the imaging optics may refer to the smallest aperture in the optical path and at the same time part of the imaging optics, whereby the exact shape of this smallest aperture, in particular with regard to a projection of the aperture onto a projection plane perpendicular to the first optical axis, would also have to be taken into account. The minimum aperture or smallest opening in the optical path of the imaging optics may advantageously also be selected to be as large as possible. The minimum aperture or smallest opening can be an aperture according to the term aperture, but also some other element, component, device, or the like as part of the imaging optics with an effect corresponding to that of an aperture, such as the frame of a lens or a wavelength-selective element (filter).

A joining plane lies within a joining zone, whereby, however without limitation of generality, a respective joining plane may lie in a joining zone at a boundary of two workpieces to be joined which are adjacent to each other in a joining zone. The focus of the laser radiation may generally not necessarily be located in the joining plane. The focal plane, in which the focus of the laser radiation lies, can form an angle with the joining plane, depending on the selected beam guidance for the laser radiation into the joining zone to the focus, so that the planes intersect. If the focus point, i.e. the central point of the focus of the laser radiation, also lies in the joining plane, then the focus point lies on the intersection line of the joining plane and the focal plane. In the case of “rather thick” first workpieces, i.e. workpieces through which the laser radiation mostly passes, the focus of the laser radiation in a joining zone is typically not at the boundary of two workpieces to be joined, but to some extent in the respective second workpiece. In the case of “rather thin” first workpieces, the focus of the laser radiation in a joining zone typically lies at the boundary of two workpieces to be joined. As a rough guideline, but without limiting the generality, a material thickness or thickness of about 0.5 mm may be mentioned here to differentiate between “rather thin” workpieces, in particular plastic films, and “rather thick” workpieces.

As already mentioned in a previous section, the heating of the workpieces to be joined due to the absorption of laser radiation in a joining zone results in the emission of thermal radiation. A portion of this thermal radiation can along the beam path through the imaging optics reach the radiation detecting device. Thermal radiation propagates from the joining zone to the coupling point in the opposite direction to the laser radiation guided into the joining zone, whereby the deflection mirror blocks the further path to the detector for part of the thermal radiation due to its arrangement in the beam path of the imaging optics or deflects parts of the thermal radiation in the direction from which the laser radiation is incident on the deflection mirror and which can therefore no longer reach the detection plane or the radiation detecting device. It is explicitly not provided that the deflection mirror on the one hand deflects incident laser radiation along the entrance axis in the direction of the second optical axis and on the other hand (at the same time) transmits incident thermal radiation along the first optical axis running parallel to the second optical axis in the opposite direction to the laser radiation. The deflection mirror is configured exclusively according to and configured for the used laser radiation. As a result, less thermal radiation reaches the detection plane than if the deflection mirror were configured to be largely transmissive for thermal radiation or were not present at all (in the beam path of the imaging optics). In return, however, there is no need for partially transparent or wavelength-selective mirrors, which are expensive to manufacture.

In a preferred embodiment of a system according to an aspect of the present disclosure for joining at least two workpieces of thermoplastic material by laser transmission welding, it is provided that the projection of the deflection mirror (onto a projection plane perpendicular to the first optical axis) covers at most two thirds, in particular not more than half, of the minimum aperture of the imaging optics. This ensures that sufficient thermal radiation from a joining zone can reach the detection plane of a radiation detecting device to generate a reliably evaluable output signal or measurement signal at the radiation detecting device.

According to a preferred embodiment of a system according to an aspect of the present disclosure for joining at least two workpieces of thermoplastic material by laser transmission welding, the first optical axis and the second optical axis coincide, i.e., laser radiation propagates between the coupling point and a joining plane in a joining zone along the (first) optical axis of the imaging optics. The beam path of laser radiation between the coupling point and a joining plane and the beam path of the imaging optics, which is followed by thermal radiation from a joining plane along the coupling point to the detection plane in the opposite direction to the laser radiation, are thus coaxial.

According to a preferred embodiment of a system according to an aspect of the present disclosure for joining at least two workpieces of thermoplastic material by laser transmission welding, at least one wavelength-selective element is arranged in a region along the first optical axis between the detection plane and the coupling point. The wavelength-selective optical element can be configured as a filter for (substantially) suppressing one or more specific wavelength ranges of the electromagnetic spectrum, whereby electromagnetic radiation from precisely this or these wavelength range(s) shall not to enter the detection plane of the radiation detecting device along the beam path of the imaging optics. This concerns in particular scattered parts of the laser radiation.

In a preferred embodiment of a system according to aspects of the invention for joining at least two workpieces of thermoplastic material by laser transmission welding, the wavelength-selective element is configured as a short-pass filter, long-pass filter, band-pass filter, or notch filter. Preferably, the wavelength-selective element is configured in particular to suppress the laser radiation (as far as possible).

According to a further particularly preferred embodiment of a system according to an aspect of the present disclosure for joining at least two workpieces of thermoplastic material by laser transmission welding, the deflection mirror is held by a deflection mirror mount, wherein the deflection mirror mount comprises at least one holder base and a holder element, the holder base having a free space which is bound or enclosed by the holder base at least partially circumferentially about the first optical axis and a projection of the free space onto a projection plane perpendicular to the first optical axis completely encloses a minimum aperture of the imaging optics, wherein at least one brace extends from the holder base in a straight line or curved into the free space and connects the holder base to the holder element, and wherein the holder element is configured to hold the deflection mirror.

The mounting or holder base of the deflection mirror mount extends at least partially and circumferentially around the first optical axis around a clearance or free space (a recess, an opening), wherein the free space (the recess, the opening) extends along the first optical axis completely through the mounting base. The free space is, with respect to its extension in a plane perpendicular to the first optical axis, at least as large as a minimum aperture of the imaging optics, so that when the free space is projected onto a plane perpendicular to the first optical axis, the projection area of the free space completely contains at least a minimum aperture of the imaging optics. In the free space (the recess, the opening) the holder element is arranged, which is connected to the holder base by at least one rectilinear or curved brace. The holder element is configured for, optionally via additional fastening means for attaching the deflection mirror to the holder element, non-destructively releasable or destructively releasable holding of the deflection mirror. Preferably, the holder element is further configured such that a projection of the holder element onto a projection plane perpendicular to the first optical axis completely covers the projection of the holder element when superimposed on a corresponding projection of the deflection mirror. This means that the holder element does not represent an additional obstacle (in addition to the obstacle that the deflection mirror already represents on its own) for thermal radiation in the optical path of the imaging optics. The holder base, the at least one brace and the holder element can each be formed in one or more parts. Preferably, the holder base, the brace(s) and the holder element are formed in one piece respectively. Particularly preferred, the holder base, brace(s) and holder element are formed in one piece together, i.e. the entire deflection mirror mount is formed as one piece.

In a further preferred embodiment of a system according to an aspect of the present disclosure for joining at least two workpieces of thermoplastic material by laser transmission welding, the radiation detecting device is configured to detect electromagnetic radiation in the near infrared range of the electromagnetic spectrum.

According to a further preferred embodiment of a system according to an aspect of the present disclosure for joining at least two workpieces of thermoplastic material by laser transmission welding, the radiation detecting device is configured to detect electromagnetic radiation in a detection range in a subrange of the electromagnetic spectrum comprising in a central region the wavelength of the laser radiation. A radiation detecting device configured in this way is preferably combined with at least one notch filter (in the beam path of the imaging optics), the notch filter then being configured to suppress electromagnetic radiation corresponding to that of the used laser radiation.

A further advantageous embodiment of a system according to an aspect of the present disclosure for joining at least two workpieces of thermoplastic material by laser transmission welding comprises adaptation of the radiation detecting device for detecting electromagnetic radiation in a detection range in a subrange of the electromagnetic spectrum in such a way that the wavelength of the laser radiation is included only in a peripheral region or not at all. Depending on whether the wavelength of the laser radiation used lies in the region of the lower limit of the detection range or in the region of the upper limit of the detection range of the radiation detecting device, a respectively adapted radiation detecting device is preferably combined with at least one long-pass filter or at least one short-pass filter (in the beam path of the imaging optics). Provided that the wavelength of the laser radiation used lies (further) outside the detection range of the radiation detecting device, filters may optionally not be necessary, provided that the radiation detecting device could not be fundamentally damaged by the laser radiation used, even if the laser radiation is not detected or cannot be detected by the radiation detecting device. A radiation detecting device adapted in this way can also be combined with at least one bandpass filter which just allows (only) electromagnetic radiation to pass corresponding to the detection range of the radiation detecting device and/or corresponding to the thermal radiation to be expected from a joining zone when irradiated with the laser.

In an additional particularly preferred embodiment of a system according to an aspect of the present disclosure for joining at least two workpieces of thermoplastic material by laser transmission welding, the radiation detecting device comprises at least one photodiode, preferably an indium gallium arsenide photodiode. Accordingly, in this embodiment, the photodiode is the actual detecting element of the radiation detecting device. The radiation detecting device may comprise only a single photodiode, i.e., be formed as a photodetector with one pixel. However, the radiation detecting device can also be configured as a photodiode line array with several pixels arranged along a (straight) line or as a photodiode array in which several pixels are arranged in a (flat) surface in a pattern. A pixel is understood to be a detection area provided or formed for the detection of electromagnetic radiation incident on the radiation detecting device as a partial area of the detection plane of the radiation detecting device. Alternative embodiments of a radiation detecting device may be bolometers or microbolometers as actual radiation detecting elements, wherein such radiation detecting devices may in turn be formed with one pixel, as a line with multiple pixels, or in the form of an array. In addition to the actual radiation detecting element(s), the radiation detecting device may comprise, for example, means for driving the actual radiation detecting elements, means for signal processing, for example of the signals of the actual radiation detecting elements caused by detectable electromagnetic radiation incident on the actual radiation detecting elements, or the like.

Basically, a radiation detecting device such as a photodiode provides a physical signal, such as an electrical signal, as an output signal or measurement signal that has a well-defined relationship to the electromagnetic radiation (thermal radiation) incident from the joining zone on the radiation detecting device and detected by the latter, and accordingly enables conclusions to be drawn about the electromagnetic radiation detected by the radiation detecting device, in particular about the power density of the detected electromagnetic radiation. In general, determining the absolute temperature of the heated and possibly melted plastic material of the workpieces to be joined in a joining zone via the thermal radiation emanating from the joining zone and detected by the radiation detecting device is difficult at best due to the numerous parameters to be taken into account in the process, including material and workpiece parameters. However, this is also by no means absolutely necessary. It can be sufficient if, for example, by means of the thermal radiation detected by the radiation detecting device and the corresponding output signal of the radiation detecting device, threshold values can be defined within which an adequate joining result can be ensured during laser transmission welding of two workpieces to be joined and the (output power of the) device for generating laser radiation can be controlled according to these threshold values. However, a control can also concern, for example, the position of the focus of laser radiation within the workpieces to be joined, e.g. relative to a joining plane. Furthermore, a control can concern the duration of irradiation of a certain area in an intended joining zone or welding zone at a boundary between two workpieces to be joined. The corresponding control then relates, for example, to the speed with which a laser head or process head, from which laser radiation is directed into a joining zone or welding zone, is moved along the joining zone or welding zone.

The features and combinations of features mentioned above in the description, as well as the features and combinations of features mentioned below in the description of the figures and/or shown only in the figures, may be used not only in the indicated combination respectively, but also in other combinations or on their own. For carrying out the invention, not all features of claim 1 need to be realized. Individual features of claim 1 may also be replaced by other disclosed features or combinations of features.

Further advantages, features and details of the invention are apparent from the claims, the following description of preferred embodiments and from the drawings, in which identical or elements having same function are provided with identical reference signs. Thereby showing:

### BRIEF DESCRIPTION OF THE DRAWINGS

FIG. 1 a schematic overview of an embodiment of a system according to an aspect of the present disclosure for joining at least two workpieces of thermoplastic material by laser transmission welding; and

FIG. 2 an exemplary deflection mirror mount together with deflection mirror for a system according to an aspect of the present disclosure for joining at least two workpieces of thermoplastic material by laser transmission welding in three-dimensional isometric representation.

### DETAILED DESCRIPTION OF EMBODIMENTS

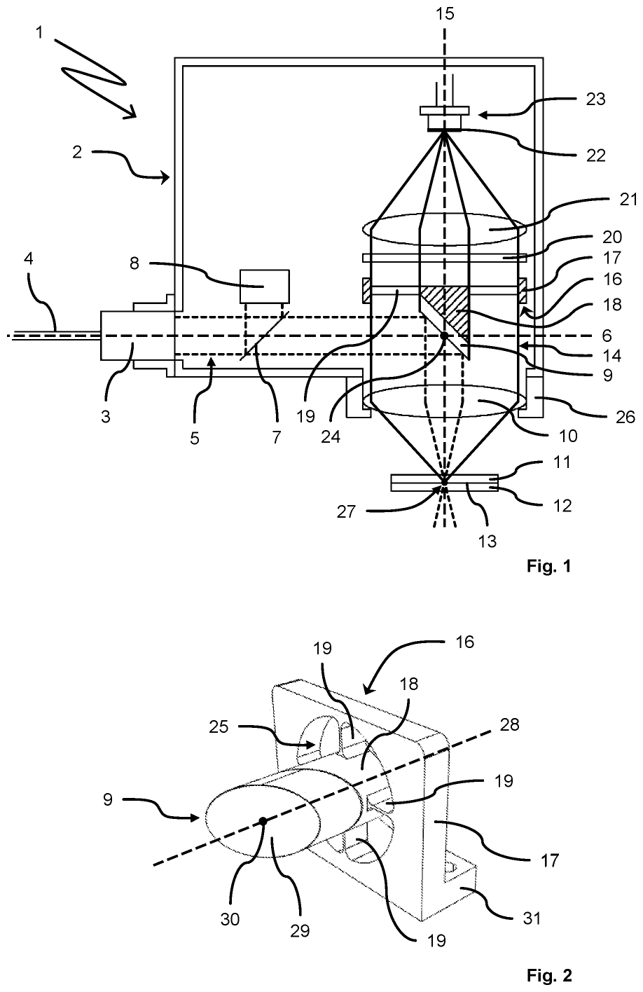

FIG. 1 shows a schematic overview of an embodiment of a system according to aspects of the invention for joining at least two workpieces made of thermoplastic material by means of laser transmission welding in the form of a process head 1 with a (process head) housing 2. Except for the feed for laser radiation 5, indicated in the form of an optical waveguide 4 with a fiber connector 3 at one end of the optical waveguide 4 leading to the housing 2 of the process head 1, all other elements of the system are arranged inside the housing 2. In the representation according to FIG. 1, the fiber connector 3 is connected laterally to the housing and has a beam expansion (not shown in further detail) for laser radiation 5 guided to the process head 1. The beam path of the laser radiation 5 entering from the fiber connector 3 into the interior of the housing 2 of the process head 1 is indicated in FIG. 1 by means of dashed lines as schematic outer beam boundaries of the laser radiation 5 perpendicular to the direction of propagation of the laser radiation 5 in accordance with the principles of ray optics or geometrical optics. After entering the housing 2, the laser radiation 5 initially propagates along the entrance axis 6.

A device for generating laser radiation, i.e. a laser radiation source or ‘laser’ for short, which can in principle also part be of a system according to an aspect of the present disclosure for joining at least two workpieces of thermoplastic material by laser transmission welding, is not shown in the representation of an exemplary embodiment according to FIG. 1, in particular because the ‘laser’ may be arranged outside the process head 1. As a result, the process head 1 can be made much more compact. Moreover, the process head 1 can be movable to some extent at least along one spatial axis and, if necessary, can additionally be rotatable and/or pivotable at least about one (further) spatial axis. As a ‘laser’ in the exemplary embodiment shown in FIG. 1, a continuous wave fiber laser with a maximum output power of 200 W, a wavelength of 1940 nm and a diffraction coefficient M²<1.1 may be provided.

At a beam splitter 7, a portion of the laser radiation 5 (about 1% to 2% of the power density of the laser radiation 5 incident on the beam splitter 7) is deflected perpendicular to the entrance axis 6 and directed to a device for laser power measurement 8. The device for laser power measurement 8 may comprise a photodiode configured for detecting the laser radiation and one or more filters for attenuating the laser radiation directed to the device for laser power measurement 8 (not shown in detail in FIG. 1) so as not to overload or even damage the photodiode. The device for laser power measurement 8 allow monitoring of the power of the ‘laser’ during operation and are thus also important for controlling the output power of the ‘laser’.

The main portion of the laser radiation 5 passes the beam splitter 7 and propagates further along the entrance axis 6 until the laser radiation 5 hits the deflection mirror 9. The deflection mirror 9 deflects the laser radiation 5 incident along the entrance axis 6 by 90°. The laser radiation 5 then propagates along the optical axis 15 in the direction of two optically transparent workpieces 11 and 12 to be joined. The optical axis 15 and the entrance axis 6 are aligned perpendicular to each other and intersect at the coupling point 24. The coupling point 24 is located in the center of the mirror surface of the deflection mirror 9. The laser radiation 5 is focused by a first lens 10. In the embodiment according to FIG. 1, the focal plane of the laser beam 5 coincides with the joining plane 13 at the boundary between the two adjacent workpieces 11 and 12 to be joined. The schematic representation in FIG. 1 follows the principles of beam or ray optics, whereby the focus is represented in a highly simplified manner as being point-shaped. Actually, the focus of the laser radiation 5 has a non-vanishing or non-zero extension in the focal plane/joint plane 13, i.e. it is a area of finite size, cf. the concept of the Gaussian beam as a more realistic approximation of the “actual” focus of a bundle of electromagnetic radiation.

On the one hand and primarily, the first lens 10 serves to focus the laser radiation 5. On the other hand and secondarily, however, the first lens 10 is also part of the imaging optics 10, 21, essentially consisting of the aforementioned first lens 10 and the second lens 21. The first lens 10 is thereby mounted in a frame 26 being part of the housing 2 of the process head 1 and is thus also a housing window. The imaging optics 10, 21 image the joining plane 13 to a detection plane 22 of a radiation detecting device indicated in the illustration in FIG. 1 as a photodiode 23. The photodiode 23 is configured as an InGaAs photodiode with one pixel. The emphasis of the detection range of the photodiode 23 is in the near infrared at wavelengths between 1500 nm and 2500 nm. The wavelength of the laser radiation 5 then lies exactly in the center of the detection range of the photodiode 23. To shield the photodiode 23 for example from parts of the laser radiation 5 reflected/scattered at optical interfaces of the first lens 10 or the workpieces 11, 12, a notch filter 20 is arranged as a wavelength-selective element in the beam path of the imaging optics 10, 21, which (almost) completely suppresses (“filters”) electromagnetic radiation with the wavelength corresponding to the laser radiation 5 in the range of 1940±50 nm, but transmits electromagnetic radiation with all other wavelengths in the detection range of the photodiode 23 (almost) unhindered.

The optical axis 15, along which the laser radiation propagates after deflection at the deflection mirror 9 in the direction of the workpieces 11, 12 to be joined, is at the same time the optical axis of the imaging optics 10, 21. A distinction between a first optical axis associated with the imaging optics 10, 21 and a second optical axis associated with the laser radiation 5 after deflection at the deflection mirror 9 is not necessary in the example shown in FIG. 1, since the axes in this case coincide anyway to form an optical axis 15. The irradiation of the workpieces 11, 12 to be joined by laser radiation 5 during the heating of the workpieces 11, 12 to be joined caused at least by partial absorption of the laser radiation 5 in a vicinity of the focus of the laser radiation 5 leads to an emission of thermal radiation. A part of this thermal radiation 14 can pass through the imaging optics 10, 21 to the detection plane 22 of the photodiode 23. The beam path of the thermal radiation 14 between the joining plane 23 and the detection plane 22 and thus the beam path of the imaging optics 10, 21 is indicated in FIG. 1 by solid lines as a symbolic outer beam boundary perpendicular to the direction of propagation of the thermal radiation 14 in accordance with the principles of ray optics or geometrical optics. Actually, similar to the focus of the laser radiation 5, there is no point-shaped emission point of the thermal radiation, but a spatial area of finite size, whereby a cross-section through this area along the joining plane/focal plane 13 completely encloses at least the (actual, finitely sized) focus 27 of the laser radiation 5. Thermal radiation 14 which reaches the first lens 10 is initially collimated thereby. In the opposite direction, the collimated laser radiation 5 guided to the first lens 10 is focused, as already mentioned. Between the coupling point 24 and the joining plane 13, the beam paths of laser radiation 5 and thermal radiation 14 run coaxially, wherein the laser radiation 5 and the thermal radiation 14 each propagate along the optical axis 15, but in opposite directions. The beam cross-section of the laser radiation 5 is considerably smaller (less than half as large) than the beam cross-section of the thermal radiation 14. However, the deflection mirror 9 for the laser radiation 5 cuts a central hole in the further beam path of the thermal radiation 14, because the deflection mirror 9 together with the holder element 18 for the deflection mirror 9 as part of the deflection mirror mount 16 is located on the optical axis 15 in the center of the beam path of the thermal radiation 14 or, respectively of the imaging optics 10, 21 and consequently makes it impossible for part of the thermal radiation 14 to reach the detection plane 22. The braces 19 as connection between the holder element 18 and the holder base 17 of the deflection mirror mount 16 lead to further small ‘losses’ of thermal radiation 14, i.e., thermal radiation 14 not reaching the detection plane 22.

Such a deflecting mirror mount 16 together with deflecting mirror 9 is exemplarily shown on its own in a three-dimensional isometric view in FIG. 2. FIG. 1 shows a cross-section through such a deflecting mirror mount 16 as part of the process head 1. The deflection mirror mount 16 comprises a holder base 17, a holder element 18 and four braces (struts) 19 connecting the holder base 17 and the holder element 18 (of the braces 19, only three are shown in FIG. 2, a fourth brace 19 is almost completely hidden by the holder element 18). The holder base 18 is flat cuboidal in shape with an extension 31 to form a pedestal on one of the two flat, wide cuboidal sides. The holder base 18 has a central free space (a clearance, a recess, an opening) 25 with a circular cross-section, which is bound or enclosed by the holder base 18 completely circumferentially around the center of the circle of the cross-section of the free space. The free space 25 extends completely through the holder base 17 parallel to the shortest sides of the holder base 17. The holder element 18 is arranged in the center of the free space 25 or concentrically to the edge of the free space 25. The holder element 18 is connected to the holder base 17 by four braces 19 extending straight from the edge into the center of the free space 25. The braces 19 are arranged equidistantly along the edge of the free space 25 (at an angle of 90° to each other). Due to the holder element 18 and additionally, although to a much lesser extent, due to the braces 19, a not inconsiderable part of the free space 25 is blocked and in this sense is no longer “free”. The holder element 18 is formed by a cylinder cut obliquely at an angle of 45° on one side, this side thus providing an angle of 45° with the cylinder symmetry axis 28. The deflection mirror 9 is fixed to this obliquely cut side of the holder element 18. The deflection mirror 9, in particular the mirror surface 29, is elliptical (the obliquely cut side of the holder element 18 is also elliptical). The deflection mirror 9 thereby fits exactly on the obliquely cut side of the holder element 18. The center of the deflection mirror 9 coincides with the cylinder symmetry axis 28 of the holder element 17, which in turn runs exactly through the center of the free space 25 (circle center of the cross section of the free space 25). If the deflection mirror mount 16 together with the deflection mirror 9, as shown in FIG. 1, is arranged as part of a system according to aspects of the invention or a process head 1, then the axis of cylindrical symmetry 28 of the holder element 17 coincides with the optical axis 15 and the center 30 of the mirror surface 29 of the elliptical deflection mirror 9, which is also the coupling point 24, lies on the optical axis, 15. The elliptical form of the deflection mirror 9 causes that, in an arrangement of the deflection mirror 9 as shown in FIG. 1, when the mirror surface 29 of the deflection mirror 9 is projected onto a projection plane perpendicular to the entrance axis 6 as well as onto a projection plane perpendicular to the optical axis 15, the respective projection of the mirror surface 29 is circular.

### LIST OF REFERENCE SIGNS

1 Process head
2 Housing
3 Fiber connector
4 optical waveguide
5 Beam path laser radiation
6 Entrance axis
7 Beam splitter
8 Device for laser power measurement
9 Deflection mirror
10 First lens
11 First workpiece
12 Second workpiece
13 Joining plane
14 Radiation path thermal radiation
15 Optical axis
16 Deflection mirror mount
17 Holder base
18 Holder element
19 Brace
20 Notch filter (wavelength selective element)
21 Second lens
22 Detection plane
23 Photodiode (radiation detecting device)
24 Coupling point
25 Free space
26 Frame
27 Focus of laser radiation
28 Symmetry axis of holder element (cylinder symmetry axis)
29 Mirror surface of deflection mirror
30 Center of mirror surface of deflection mirror
31 Extension/Socket of holder base

What is claimed is:

1. A system for joining at least two workpieces of thermoplastic material by laser transmission welding, the system comprising at least one device for generating laser radiation and an imaging optics having a first optical axis, wherein laser radiation emitted by the device for generating laser radiation is guided into a joining zone, and wherein the imaging optics is configured for optical imaging from a joining plane in the joining zone to a detection plane of a radiation detecting device, wherein a deflection mirror is provided at a coupling point on a second optical axis, running parallel to the first optical axis, for deflecting the laser radiation from an entrance axis enclosing a nonzero angle, preferably a right angle, with the second optical axis, into a direction along the second optical axis, wherein the distance between the coupling point and the joining plane with respect to the second optical axis is smaller than the distance from the detection plane to the joining plane with respect to the first optical axis, wherein the diameter of the deflection mirror is adapted to a cross-sectional shape and cross-sectional size of the laser radiation and, when projecting the deflection mirror onto a projection plane perpendicular to the first optical axis, the projection area of the deflection mirror in the projection plane is arranged completely within a minimum aperture in the beam path of the imaging optics and only partially covers the minimum aperture.

2. The system according to claim 1, wherein the projection of the deflection mirror covers at most two thirds of the minimum aperture of the imaging optics.

3. The system according to claim 1, wherein the first optical axis and the second optical axis coincide to form a common optical axis.

4. The system according to claim 1, wherein at least one wavelength selective element is arranged in a region along the first optical axis between the detection plane and the coupling point.

5. The system according to claim 4, wherein the wavelength selective element is formed as a short pass filter, long pass filter, band pass filter or notch filter.

6. The system according to claim 1, wherein the deflection mirror is held by a deflection mirror mount, wherein the deflection mirror mount comprises at least one holder base and a holder element, the holder base having a free space which is bound or enclosed by the holder base at least partially circumferentially about the first optical axis and a projection of the free space onto a projection plane perpendicular to the first optical axis completely encloses a minimum aperture of the imaging optics, wherein at least one brace extends from the holder base in a straight line or curved into the free space and connects the holder base to the holder element, and wherein the holder element is configured to hold the deflection mirror.

7. The system according to claim 1, wherein the radiation detecting device is configured to detect electromagnetic radiation in the near infrared region of the electromagnetic spectrum.

8. The system according to claim 1, wherein the radiation detecting device is configured to detect electromagnetic radiation in a detection range in a subrange of the electromagnetic spectrum comprising in a central region the wavelength of the laser radiation.

9. The system according to claim 1, wherein the radiation detecting device is configured to detect electromagnetic radiation in a detection range in a subrange of the electromagnetic spectrum that comprises the wavelength of the laser radiation only in a peripheral region or not at all.

10. The system according to claim 1, wherein the radiation detecting device comprises at least one photodiode, in particular an indium-gallium-arsenide photodiode.

11. The system according to claim 2, wherein the projection of the deflection mirror covers not more than half of the minimum aperture of the imaging optics.
